(19) United States
(12) Patent Application Publication
(10) Pub. No.: US 2026/0119580 A1
(43) Pub. Date: Apr. 30, 2026

(54) DATA PROCESSING METHOD AND APPARATUS

(71) Applicant: Beijing Volcano Engine Technology Co., Ltd., Beijing (CN)

(72) Inventor: Hao WANG, Beijing (CN)

(21) Appl. No.: 19/371,256

(22) Filed: Oct. 28, 2025

(30) Foreign Application Priority Data
Oct. 29, 2024 (CN) 202411525018.3

(51) Int. Cl. G06F 16/9032; G06F 16/903

(52) U.S. Cl. CPC G06F 16/90328; G06F 16/90335

(57) ABSTRACT

The present application provides a data processing method. The method includes obtaining a search term input by a user, where the search term is used to search for a field in a target data table. A first field to be matched is obtained, where the first field is a field related to the target data table. A first prefix matching degree between the search term and the first field and a first suffix matching degree between the search term and the first field are determined, so that a similarity between the first field and the search term is determined based on the first prefix matching degree and the first suffix matching degree.

### CROSS-REFERENCE TO RELATED APPLICATION

This application claims priority to Chinese Application No. 202411525018.3 filed on Oct. 29, 2024, the disclosure of which is incorporated herein by reference in its entirety.

### FIELD

The present application relates to the field of data processing and, in particular, to a data processing method and apparatus.

### BACKGROUND

A user may query data that the user expects to view in a data table by inputting a search term. At present, a similarity between the search term input by the user and a field in the data table may be calculated by using a Jaro-Winkler algorithm, and a field whose similarity to the search term is higher than a certain threshold is fed back to the user as a search result.

### SUMMARY

To solve or at least partially solve the above technical problem, the present application provides a data processing method and apparatus.

According to a first aspect, the present application provides a data processing method. The method includes:
obtaining a search term input by a user, where the search term is used to search for a field in a target data table;
obtaining a first field to be matched, where the first field is a field related to the target data table;
determining a first prefix matching degree between the search term and the first field and a first suffix matching degree between the search term and the first field; and
determining a similarity between the first field and the search term based on the first prefix matching degree and the first suffix matching degree.

Optionally, the method further includes:
determining a keyword of the search term and a keyword of the first field; and
determining a keyword matching degree between the search term and the first field based on the keyword of the search term and the keyword of the first field, where the determining the similarity between the first field and the search term based on the first prefix matching degree and the first suffix matching degree includes:
determining the similarity between the first field and the search term based on the first prefix matching degree, the first suffix matching degree, and the keyword matching degree.

Optionally, the first field is a field included in the target data table.

Optionally, the method further includes:
outputting the first field if the similarity between the first field and the search term is greater than or equal to a preset threshold.

Optionally, the method further includes:
obtaining an alias of the first field as a second field if the similarity between the first field and the search term is less than a preset threshold;
determining a second prefix matching degree between the search term and the second field and a second suffix matching degree between the search term and the second field;
determining a similarity between the second field and the search term based on the second prefix matching degree and the second suffix matching degree; and
outputting the first field if the similarity between the second field and the search term is greater than or equal to the preset threshold.

Optionally, the first field is an alias of a third field, and the third field is a field included in the target data table.

Optionally, the method further includes:
outputting the first field as a recommended search term if the similarity between the first field and the search term is greater than or equal to a preset threshold.

Optionally, the method further includes:
outputting the third field if the similarity between the first field and the search term is greater than or equal to a preset threshold.

Optionally, the method further includes:
inputting a prompt into a large model, where the prompt includes at least a target field and an association relationship between the target field and another field in the target data table, the target field is a field in the target data table, the target field includes the first field or the third field, and the prompt is used to prompt the large model to generate an alias for the target field based on the association relationship and/or the target field; and
obtaining the alias of the target field that is output by the large model.

According to a second aspect, the present application provides a data processing apparatus. The apparatus includes:
a first obtaining unit, configured to obtain a search term input by a user, where the search term is used to search for a field in a target data table;
a second obtaining unit, configured to obtain a first field to be matched, where the first field is a field related to the target data table;
a first determining unit, configured to determine a first prefix matching degree between the search term and the first field and a first suffix matching degree between the search term and the first field; and
a second determining unit, configured to determine a similarity between the first field and the search term based on the first prefix matching degree and the first suffix matching degree.

Optionally, the apparatus further includes:
a third determining unit, configured to determine a keyword of the search term and a keyword of the first field;
a fourth determining unit, configured to determine a keyword matching degree between the search term and the first field based on the keyword of the search term and the keyword of the first field, where the second determining unit is further configured to:
determine the similarity between the first field and the search term based on the first prefix matching degree, the first suffix matching degree, and the keyword matching degree.

Optionally, the first field is a field included in the target data table.

Optionally, the apparatus further includes:
a first output unit, configured to output the first field if the similarity between the first field and the search term is greater than or equal to a preset threshold.

Optionally, the apparatus further includes:
a third obtaining unit, configured to obtain an alias of the first field as a second field if the similarity between the first field and the search term is less than a preset threshold;
a fifth determining unit, configured to determine a second prefix matching degree between the search term and the second field and a second suffix matching degree between the search term and the second field;
a sixth determining unit, configured to determine a similarity between the second field and the search term based on the second prefix matching degree and the second suffix matching degree; and
a second output unit, configured to output the first field if the similarity between the second field and the search term is greater than or equal to the preset threshold.

Optionally, the first field is an alias of a third field, and the third field is a field included in the target data table.

Optionally, the apparatus further includes:
a third output unit, configured to output the first field as a recommended search term if the similarity between the first field and the search term is greater than or equal to a preset threshold.

Optionally, the apparatus further includes:
a fourth output unit, configured to output the third field if the similarity between the first field and the search term is greater than or equal to a preset threshold.

Optionally, the apparatus further includes:
an input unit, configured to input a prompt into a large model, where the prompt includes at least a target field and an association relationship between the target field and another field in the target data table, the target field is a field in the target data table, the target field includes the first field or the third field, and the prompt is used to prompt the large model to generate an alias for the target field based on the association relationship and/or the target field; and
a fourth obtaining unit, configured to obtain the alias of the target field that is output by the large model.

According to a third aspect, an embodiment of the present application provides an electronic device. The electronic device includes a processor and a memory.

The processor is configured to execute instructions stored in the memory, to cause the electronic device to perform the method according to any one of the first aspect above.

According to a fourth aspect, an embodiment of the present application provides a computer-readable storage medium. The computer-readable storage medium includes instructions, and the instructions instruct a device to perform the method according to any one of the first aspect above.

According to a fifth aspect, an embodiment of the present application provides a computer program product. When the computer program product runs on a computer, the computer is caused to perform the method according to any one of the first aspect above.

### BRIEF DESCRIPTION OF THE DRAWINGS

To describe the technical solutions in the embodiments of the present application or in the prior art more clearly, the following briefly introduces the drawings required for describing the embodiments or the prior art. Apparently, the drawings in the following description show merely some embodiments of the present application, and a person of ordinary skill in the art may derive other drawings from these drawings without creative efforts.

FIG. 1 is a flowchart of a data processing method according to an embodiment of the present application.

FIG. 2 is a flowchart of another data processing method according to an embodiment of the present application.

FIG. 3 is a flowchart of yet another data processing method according to an embodiment of the present application.

FIG. 4 is a schematic structural diagram of a data processing apparatus according to an embodiment of the present application.

### DETAILED DESCRIPTION OF EMBODIMENTS

To enable a person skilled in the art to better understand the solutions of the present application, the following clearly and comprehensively describes the technical solutions in the embodiments of the present application with reference to the drawings in the embodiments of the present application. Apparently, the described embodiments are merely a part rather than all of the embodiments of the present application. All other embodiments obtained by a person of ordinary skill in the art based on the embodiments of the present application without creative efforts shall fall within the protection scope of the present application.

The inventors of the present application have found through research that in the prior art, a similarity between a search term input by a user and a field in a data table may be calculated by using a Jaro-Winkler algorithm.

The principle of calculating a similarity between two texts (text 1 and text 2) by using the Jaro-Winkler algorithm is as follows:

Firstly, a Jaro distance between the two texts is calculated based on formula 1.

$$s i m = \{ \begin{matrix}0 & if m = 0 \\ \frac{1}{3} ( \frac{m}{\vert s 1 \vert} + \frac{m}{\vert s 2 \vert} + \frac{m + t}{m} ) & otherwise\end{matrix} \qquad formula ( 1 )$$

In formula (1):
sim represents a Jaro distance between text 1 and text 2;
S1 represents the number of characters included in text 1;
S2 represents the number of characters included in text 2;
m represents the number of characters matched between text 1 and text 2 in a window with a character length of

$$⌊ \frac{max ( S 1 , S 2 )}{2} ⌋ - 1 ; ⌊ \frac{max ( S 1 , S 2 )}{2} ⌋$$

represents rounding down

$$\frac{max ( S 1 , S 2 )}{2} ;$$

and t represents the number of transpositions.

Further, a similarity between the two texts is obtained by using the Jaro distance and a prefix matching degree between the two texts based on formula 2.

$$J = s i m + p * ( 1 - s i m ) \qquad formula ( 2 )$$

In formula (2):
J represents a similarity between text 1 and text 2;
sim represents a Jaro distance between text 1 and text 2 that is calculated by using formula (1); and
p represents a prefix matching degree between text 1 and text 2.

The current Jaro-Winkler algorithm provides a relatively accurate calculation result when calculating a similarity between person names. However, in a data table search scenario, the calculation result is often not accurate. Especially in a scenario where a data table includes a large number of fields and a user does not have a good understanding of names of the fields in the data table, a similarity between two texts is calculated by using the Jaro-Winkler algorithm, and a search result is output to the user based on a calculation result. The output search result often cannot meet the requirements of the user.

In view of this, the present application provides a data processing method and apparatus, which can more accurately determine a field matching the search term in the data table in a data table search scenario, so that the output search result better meets the requirements of the user.

The present application provides a data processing method. The method includes: obtaining a search term input by a user, where the search term is used to search for a field in a target data table. A first field to be matched is obtained, where the first field is a field related to the target data table. Furthermore, a similarity between the first field and the search term is determined, so as to further determine a field in the target data table matching the search term. In the present application, when determining the similarity between the first field and the search term, a first prefix matching degree between the search term and the first field and a first suffix matching degree between the search term and the first field may be determined, so that the similarity between the first field and the search term is determined based on the first prefix matching degree and the first suffix matching degree. That is, when determining the similarity between the first field and the search term, not only a matching degree between the first field and the search term in a prefix but also a matching degree between the first field and the search term in a suffix are considered, so that the determined similarity between the first field and the search term is more accurate. Correspondingly, a field in the target data table matching the search term can be more accurately determined based on the similarity between the first field and the search term, so that the output search result better meets the requirements of the user.

Various non-restrictive implementations of the present application are described in detail below with reference to the drawings.

### Exemplary Method

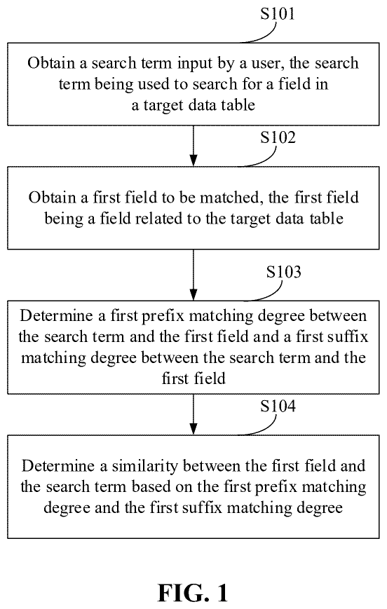

FIG. 1 is a flowchart of a data processing method according to an embodiment of the present application.

The data processing method provided in this embodiment of the present application may be applied to a client or a server, which is not specifically limited in the embodiments of the present application. In the following description, an example in which the method is applied to a client is used for description.

In this embodiment, the method may include the following steps, for example: S101 to S104.

S101: a search term input by a user is obtained, where the search term is used to search for a field in a target data table.

In an example, the user may input the search term in a search term input area provided by the client.

As an example, after the user triggers a preset operation in a display page of the target data table, the client displays the search term input area in response to the preset operation. Further, the user may input the search term in the search term input area. The preset operation mentioned here may be triggering a search operation (for example, triggering a search operation by using a shortcut key “ctrl+F”).

As another example, the search term input area may also be directly displayed on the display page of the client, without the user triggering the aforementioned preset operation, which is not specifically limited in the embodiments of the present application.

The search term is not specifically limited in the embodiments of the present application, and the search term may include one or more characters. The character mentioned here includes but is not limited to one or more characters such as a Chinese character, an English character, a Korean character, and a Japanese character.

S102: a first field to be matched is obtained, where the first field is a field related to the target data table.

In an example, after the search term is obtained, the first field to be matched may be further obtained, so as to further calculate a similarity between the first field and the search term, thereby further determining a field in the target data table matching the search term based on the similarity between the first field and the search term.

In the present application, the first field is a field related to the target data table. The field related to the target data table may be a field in the target data table, or may be another field derived from the field in the target data table. In other words, in a specific example, the first field is a field included in the target data table. In another specific example, the first field may be a field derived from a third field in the target data table. For example, the first field may be an alias of the third field.

In the present application, the similarity between the first field and the search term may be determined through S103 to S104.

S103: a first prefix matching degree between the search term and the first field and a first suffix matching degree between the search term and the first field are determined.

In the present application, considering that a field naming in the data table may follow a paradigm of “prefix+**” or “** +suffix”, a similarity between the search term and the first field may be determined based on the first prefix matching degree between the search term and the first field and the first suffix matching degree between the search term and the first field.

In an example, the search term and the first field may be matched to obtain a common prefix length between the search term and the first field, and the first prefix matching degree is obtained based on the common prefix length between the search term and the first field. As a specific example, the first prefix matching degree may be obtained by multiplying the common prefix length by a first scaling factor. For example, if the common prefix length is 4 and the first scaling factor is 0.1, the first prefix matching degree is 0.4.

In an example, to avoid an excessively large first prefix matching degree from affecting the accuracy of the calculated similarity between the first field and the search term, an upper limit may be set for the first prefix matching degree, and when a prefix matching degree calculated based on the common prefix length and the first scaling factor is greater than the upper limit, the upper limit is used as the first prefix matching degree. Alternatively, an upper limit (for example, 4) may be set for the aforementioned common prefix length, and when the matched common prefix length is greater than the upper limit, the first prefix matching degree is calculated based on the upper limit of the common prefix length and the first scaling factor.

In an example, the search term and the first field may be matched, to obtain a common suffix length between the search term and the first field, and the first suffix matching degree is obtained based on the common suffix length between the search term and the first field. As a specific example, the first suffix matching degree may be obtained by multiplying the common suffix length by a second scaling factor. For example, if the common suffix length is 4 and the second scaling factor is 0.1, the first suffix matching degree is 0.4.

In an example, to avoid an excessively large first suffix matching degree from affecting the accuracy of the calculated similarity between the first field and the search term, an upper limit may be set for the first suffix matching degree, and when a suffix matching degree calculated based on the common suffix length and the second scaling factor is greater than the upper limit, the upper limit is used as the first suffix matching degree. Alternatively, an upper limit (for example, 4) may be set for the aforementioned common suffix length, and when the matched common suffix length is greater than the upper limit, the first suffix matching degree is calculated based on the upper limit of the common suffix length and the second scaling factor.

S104: the similarity between the first field and the search term is determined based on the first prefix matching degree and the first suffix matching degree.

After the first prefix matching degree and the first suffix matching degree are obtained, the similarity between the first field and the search term may be determined based on the first prefix matching degree and the first suffix matching degree.

As an example, weighted calculation may be performed on the first prefix matching degree and the first suffix matching degree, to obtain the similarity between the first field and the search term.

As another example, the similarity between the first field and the search term may be obtained based on the first prefix matching degree, the first suffix matching degree, and a Jaro distance between the first field and the search term. As a specific example, the first prefix matching degree, the first suffix matching degree, and the Jaro distance between the first field and the search term are weighted, to obtain the similarity between the first field and the search term. For example, the similarity between the first field and the search term may be obtained based on the following formula (3).

$$J 1 = J + S * ( 1 - J ) \qquad formula ( 3 )$$

In formula (3):
J1 represents the similarity between the first field and the search term, that is, a calculation result of S104;
J represents a similarity between the first field and the search term that is calculated by using formula (2); and
S represents the first suffix matching degree.

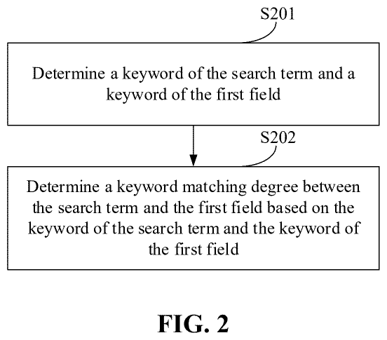

As another example, considering that the field in the target data table may not follow the paradigm of “prefix+**” or “** +suffix”, in this case, to accurately determine the similarity between the first field and the search term, the client may further perform S201 to S202 shown in FIG. 2. FIG. 2 is a flowchart of another data processing method according to an embodiment of the present application.

S201: a keyword of the search term and a keyword of the first field are determined.

In an example, a keyword extraction algorithm may be used to extract the keyword of the search term and the keyword of the first field.

In another example, a model (for example, a large language model) may be used to determine the keyword of the search term and the keyword of the first field. For example, the search term and the first field are separately input into the model, so that the keyword of the search term and the keyword of the first field are determined by using the model.

S202: a keyword matching degree between the search term and the first field is determined based on the keyword of the search term and the keyword of the first field.

After the keyword of the search term and the keyword of the first field are determined, the keyword matching degree between the search term and the first field may be determined based on the keyword of the search term and the keyword of the first field. As a specific example, a similarity between the keyword of the search term and the keyword of the first field may be calculated, and the similarity between the keyword of the search term and the keyword of the first field is used as the keyword matching degree between the search term and the first field.

In an example, when the similarity between the keyword of the search term and the keyword of the first field is calculated, for example, a first word embedding of the keyword of the search term may be calculated, and a second word embedding of the keyword of the first field is calculated. A cosine similarity between the first word embedding and the second word embedding is calculated, to obtain the similarity between the keyword of the search term and the keyword of the first field.

Correspondingly, in the scenario where the client further performs S201 to S202 to determine the keyword matching degree, when S104 is implemented, the similarity between the first field and the search term may be determined based on the first prefix matching degree, the first suffix matching degree, and the keyword matching degree.

As a specific example, weighted calculation may be performed on the first prefix matching degree, the first suffix matching degree, and the keyword matching degree, to obtain the similarity between the first field and the search term.

As another specific example, the similarity between the first field and the search term may be obtained based on the first prefix matching degree, the first suffix matching degree, the keyword matching degree, and a Jaro distance between the first field and the search term. As an example, the first prefix matching degree, the first suffix matching degree, the keyword matching degree, and the Jaro distance between the first field and the search term are weighted, to obtain the similarity between the first field and the search term. For example, the similarity between the first field and the search term may be obtained based on the following formula (4).

$$J 2 = J + S * ( 1 - J ) + k * ( 1 - J ) \qquad formula ( 4 )$$

In formula (4):
J2 represents the similarity between the first field and the search term, that is, a calculation result of S104;
J represents a similarity between the first field and the search term that is calculated by using formula (2);
S represents the first suffix matching degree; and
k represents the keyword matching degree.

The formula (4) is described below by using an example in which the search term is “first level track” and the first field is “first level subordinate track”.

A common prefix length between “first level track” and “first level subordinate track” is 2, and therefore a first prefix matching degree between “first level track” and “first level subordinate track” is 0.2.

A common suffix length between “first level track” and “first level subordinate track” is 2, and therefore a first suffix matching degree between “first level track” and “first level subordinate track” is 0.2.

Keywords of “first level track” include “first level” and “track”, and keywords of “first level subordinate track” include “first level” and “subordinate track”. A similarity between the keywords {first level, track} and {first level, subordinate track} is calculated. Assuming that the calculated similarity between the keywords {first level, track} and {first level, subordinate track} is 0.8, a keyword matching degree between “first level track” and “first level subordinate track” is 0.8.

In addition, a Jaro distance between “first level track” and “first level subordinate track” is calculated by using the formula (1).

In the formula (1):
S1 is equal to 4, S2 is equal to 5, m is equal to 4, and t is equal to 0.

The Jaro distance between “first level track” and “first level subordinate track” is obtained by using the formula (1):

$$\frac{1}{3} ( \frac{4}{5} + \frac{4}{4} + \frac{4 - 0}{4} ) = \frac{1}{3} ( 0.8 + 1 + 1 ) = \frac{1}{3} \times 2.8 \approx 0.9333 .$$

The Jaro distance calculated based on the formula (1) is substituted into the formula (2), to obtain J=0.9333+0.2*(1−0.9333)=0.94664.

Further, J calculated based on the formula (2), and S and K are substituted into the formula (4), to obtain the similarity between “first level track” and “first level subordinate track”:

$$0. 94664 + 0.2 * ( 1 - 94664 ) + 0.8 * ( 1 - 94664 ) = 1 .$$

In some scenarios, the result calculated based on the formula (4) may be greater than 1. In this case, it may be considered that the similarity between the first field and the search term is 1.

It can be known from the foregoing description that, using the solution provided in the embodiments of the present application, when determining the similarity between the first field and the search term, not only the matching degree between the first field and the search term in the prefix but also the matching degree between the first field and the search term in the suffix are considered, and in some scenarios, the keyword matching degree between the first field and the search term is also considered, so that the determined similarity between the first field and the search term is more accurate. Correspondingly, the field in the target data table matching the search term can be more accurately determined based on the similarity between the first field and the search term, so that the output search result better meets the requirements of the user.

It can be learned from the foregoing description that the first field may be a field in the target data table, or may be an alias of the third field in the target data table.

If the first field is a field in the target data table, in an example, if the similarity between the first field and the search term is greater than or equal to a preset threshold, the client may output the first field. Specifically, the client may output the first field as a search result. For example, the first field may be displayed in a specific style in the page in which the target data table is displayed, or the first field may be displayed in a center area of the page displayed by the client, which is not specifically limited in the embodiments of the present application.

The preset threshold is not specifically limited in the embodiments of the present application, and the preset threshold may be set based on an actual situation. For example, the preset threshold may be 0.8.

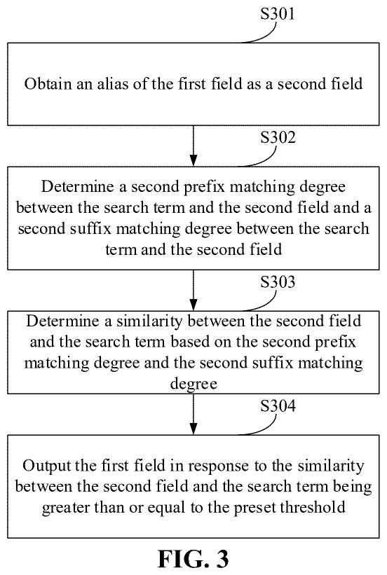

If the first field is a field in the target data table, in another example, if the similarity between the first field and the search term is less than the preset threshold, the client may further perform S301 to S304 shown in FIG. 3. FIG. 3 is a flowchart of still another data processing method according to an embodiment of the present application.

S301: an alias of the first field is obtained as a second field.

In the present application, each of at least one field in the target data table may have at least one alias. When the first field is a field in the target data table, the at least one field mentioned here may at least include the first field. When the first field is an alias of the third field, the at least one field mentioned here may at least include the third field.

S302: a second prefix matching degree between the search term and the second field and a second suffix matching degree between the search term and the second field are determined.

S303: a similarity between the second field and the search term is determined based on the second prefix matching degree and the second suffix matching degree.

S302 to S303 are implemented based on the same principle as S103 to S104. For a specific implementation of S302 to S303, reference may be made to the description of S103 to S104 above, and details are not described herein again.

S304: the first field is output if the similarity between the second field and the search term is greater than or equal to the preset threshold.

In an example, if the similarity between the second field and the search term is greater than or equal to the preset threshold, it represents that the similarity between the search term and the second field is high. In this case, since the second field is an alias of the first field, the first field may be output. For example, the first field may be output as a search result. For a specific implementation of outputting the first field, reference may be made to the related description above, and details are not described herein again.

It can be learned from S301 to S304 that even if the similarity between the search term input by the user and the first field in the target data table is low, the first field may also be retrieved from the target data table as the search result by matching the search term with the alias of the first field. That is, using this solution, in a case where the user does not know a field name in the target data table, if the user knows information about a field that the user wants to search for, the user can accurately obtain the search result by matching the search term with the alias. For example:

It is assumed that a field in the target database is “customer_address”, the field has an alias “client_location”, and a search term input by the user is “customer_location”.

Firstly, “customer_address” may be used as the first field, and the similarity between the first field and the search term is calculated. Assuming that the calculated similarity is low and is 0.6.

Further, “client_location” is used as the second field, and the similarity between the second field and the search term is calculated. Assuming that the calculated similarity is 1.0.

Since the similarity between the second field and the search term is greater than or equal to the preset threshold (assuming that the preset threshold is 0.8), the first field “customer_address” may be output as the search result.

If the first field is an alias of the third field, and if the similarity between the first field and the search term is greater than or equal to the preset threshold, in a specific example, the client may output the third field. Specifically, the client may output the third field as a search result. For a specific implementation of outputting the third field as a search result, reference may be made to the specific description of “outputting the first field as a search result” above, and details are not described herein again.

If the first field is an alias of the third field, and if the similarity between the first field and the search term is greater than or equal to the preset threshold, in another specific example, the first field may be output as a recommended search term. For example, the page displayed by the client includes a search term recommendation area in addition to the search term input area, and the search term recommendation area is used to display a search term recommended by the client. In this case, the client may display the first field in the search term recommendation area, and the user may trigger a selection operation by using the recommended search term, so as to quickly input the recommended search term into the search term input area, thereby optimizing the search term input by the user, which is helpful for providing a more accurate search result for the user. In this scenario, the client may perform a search based on the aforementioned search term and recommended search term (that is, the first field). Since the first field is an alias of the third field, the client can accurately output the third field as the search result, so that the output search result better meets the requirements of the user.

Next, an alias obtaining method for a field is described.

For ease of description, any field with an alias in the data table is referred to as a “target field”, and the target field may be the third field or the first field. In an example, the alias of the target field may be set by the user. In another example, the alias of the target field may be obtained through the following steps A1 and A2.

A1: a prompt is input into a large model, where the prompt includes at least a target field and an association relationship between the target field and another field in the target data table, and the prompt is used to prompt the large model to generate an alias for the target field based on the association relationship and/or the target field.

A2: the alias of the target field that is output by the large model is obtained.

The large model mentioned in steps A1 and A2 may be, for example, a large language model, or may be a model that at least has a function of generating an alias for a field, which is not specifically limited in the embodiments of the present application.

In some scenarios, the association relationship between the target field and another field may also be referred to as a blood relationship between the template field and another field. In a specific example, the association relationship may at least include the target field and an upstream field of the target field, where the target field may be obtained based on the upstream field of the target field. Certainly, the association relationship may also include the target field and a downstream field of the target field, where the downstream field of the target field is a field obtained after the target field is processed.

After the target field and the association relationship are input into the large model, the large model may generate an alias for the target field based on the target field and/or the association relationship. For example, the large model may generate an alias with similar semantics for the target field based on a semantics of the target field. For another example, the large model may generate an alias for the target field based on the association relationship (for example, a name of the upstream field). For another example, the large model may generate an alias for the target field based on the semantics of the target field and the association relationship.

### Exemplary Device

Based on the method provided in the foregoing embodiments, an embodiment of the present application further provides an apparatus, and the apparatus is described below with reference to the drawings.

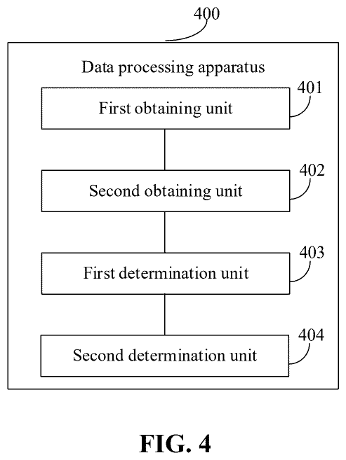

FIG. 4 is a schematic structural diagram of a data processing apparatus according to an embodiment of the present application. The apparatus 400 shown in FIG. 4 is configured to perform the data processing method provided in the foregoing method embodiments.

The apparatus 400 may specifically include, for example, a first obtaining unit 401, a second obtaining unit 402, a first determining unit 403, and a second determining unit 404.

The first obtaining unit 401 is configured to obtain a search term input by a user, where the search term is used to search for a field in a target data table.

The second obtaining unit 402 is configured to obtain a first field to be matched, where the first field is a field related to the target data table.

The first determining unit 403 is configured to determine a first prefix matching degree between the search term and the first field and a first suffix matching degree between the search term and the first field.

The second determining unit 404 is configured to determine a similarity between the first field and the search term based on the first prefix matching degree and the first suffix matching degree.

Optionally, the apparatus further includes:
a third determining unit, configured to determine a keyword of the search term and a keyword of the first field; and
a fourth determining unit, configured to determine a keyword matching degree between the search term and the first field based on the keyword of the search term and the keyword of the first field, where the second determining unit 404 is specifically configured to:
determine the similarity between the first field and the search term based on the first prefix matching degree, the first suffix matching degree, and the keyword matching degree.

Optionally, the first field is a field included in the target data table.

Optionally, the apparatus further includes:
a first output unit, configured to output the first field if the similarity between the first field and the search term is greater than or equal to a preset threshold.

Optionally, the apparatus further includes:
a third obtaining unit, configured to obtain an alias of the first field as a second field if the similarity between the first field and the search term is less than a preset threshold;
a fifth determining unit, configured to determine a second prefix matching degree between the search term and the second field and a second suffix matching degree between the search term and the second field;
a sixth determining unit, configured to determine a similarity between the second field and the search term based on the second prefix matching degree and the second suffix matching degree; and
a second output unit, configured to output the first field if the similarity between the second field and the search term is greater than or equal to the preset threshold.

Optionally, the first field is an alias of a third field, and the third field is a field included in the target data table.

Optionally, the apparatus further includes:
a third output unit, configured to output the first field as a recommended search term if the similarity between the first field and the search term is greater than or equal to a preset threshold.

Optionally, the apparatus further includes:
a fourth output unit, configured to output the third field if the similarity between the first field and the search term is greater than or equal to a preset threshold.

Optionally, the apparatus further includes:
an input unit, configured to input a prompt into a large model, where the prompt includes at least a target field and an association relationship between the target field and another field in the target data table, the target field is a field in the target data table, the target field includes the first field or the third field, and the prompt is used to prompt the large model to generate an alias for the target field based on the association relationship and/or the target field; and
a fourth obtaining unit, configured to obtain the alias of the target field that is output by the large model.

The apparatus 400 is an apparatus corresponding to the data processing method provided in the foregoing method embodiments. Specific implementations of the units of the apparatus 400 are based on the same concept as the foregoing method embodiments. Therefore, for the specific implementations of the units of the apparatus 400, reference may be made to the related description of the foregoing method embodiments, and details are not described herein again.

An embodiment of the present application provides an electronic device, and the electronic device includes a processor and a memory.

The processor is configured to execute instructions stored in the memory, to cause the electronic device to perform the method according to the above method embodiments.

An embodiment of the present application provides a computer-readable storage medium. The computer-readable storage medium includes instructions, and the instructions instruct a device to perform the method according to the above method embodiments.

An embodiment of the present application provides a computer program product. When the computer program product runs on a computer, the computer is caused to perform the method according to the above method embodiments.

A person skilled in the art may easily think of other implementations of the present application after considering the specification and practicing the disclosed invention. The present application is intended to cover any variation, use or adaptation of the present application. These variations, uses or adaptations follow the general principles of the present application and include common knowledge or conventional technical means in the art that are not disclosed in the present disclosure. The specification and the embodiments are merely considered as exemplary, and the true scope and spirit of the present application are pointed out by the following claims.

It should be understood that the present application is not limited to the precise structure described above and shown in the drawings, and various modifications and changes may be made without departing from the scope of the present application. The scope of the present application is limited only by the appended claims.

The above descriptions are merely preferred embodiments of the present application, and are not intended to limit the present application. Any modification, equivalent replacement, improvement, or the like made within the spirit and principle of the present application shall be included in the protection scope of the present application.

I/We claim:

1. A data processing method, comprising:
obtaining a search term input by a user, the search term being used to search for a field in a target data table;
obtaining a first field to be matched, the first field being a field related to the target data table;
determining a first prefix matching degree between the search term and the first field and a first suffix matching degree between the search term and the first field; and
determining a similarity between the first field and the search term based on the first prefix matching degree and the first suffix matching degree.

2. The method according to claim 1, wherein the method further comprises:
determining a keyword of the search term and a keyword of the first field; and
determining a keyword matching degree between the search term and the first field based on the keyword of the search term and the keyword of the first field, wherein determining the similarity between the first field and the search term based on the first prefix matching degree and the first suffix matching degree comprises:
determining the similarity between the first field and the search term based on the first prefix matching degree, the first suffix matching degree, and the keyword matching degree.

3. The method according to claim 1, wherein the first field is a field comprised in the target data table.

4. The method according to claim 3, wherein the method further comprises:
outputting the first field in response to the similarity between the first field and the search term being greater than or equal to a preset threshold.

5. The method according to claim 3, wherein the method further comprises:
obtaining an alias of the first field as a second field in response to the similarity between the first field and the search term being less than a preset threshold;
determining a second prefix matching degree between the search term and the second field and a second suffix matching degree between the search term and the second field;
determining a similarity between the second field and the search term based on the second prefix matching degree and the second suffix matching degree; and
outputting the first field in response to the similarity between the second field and the search term being greater than or equal to the preset threshold.

6. The method according to claim 1, wherein the first field is an alias of a third field, and the third field is a field comprised in the target data table.

7. The method according to claim 6, wherein the method further comprises:
outputting the first field as a recommended search term in response to the similarity between the first field and the search term being greater than or equal to a preset threshold.

8. The method according to claim 6, wherein the method further comprises:
outputting the third field in response to the similarity between the first field and the search term being greater than or equal to a preset threshold.

9. The method according to claim 6, wherein the method further comprises:
inputting a prompt into a large model, wherein the prompt comprises at least a target field and an association relationship between the target field and another field in the target data table, the target field is a field in the target data table, the target field comprises the first field or the third field, and the prompt is used to prompt the large model to generate an alias for the target field based on the association relationship and/or the target field; and
obtaining the alias of the target field that is output by the large model.

10. An electronic device, comprising a processor and a memory having instructions stored thereon, wherein the instructions, when executed by the processor, cause the electronic device to:
obtain a search term input by a user, the search term being used to search for a field in a target data table;
obtain a first field to be matched, the first field being a field related to the target data table;
determine a first prefix matching degree between the search term and the first field and a first suffix matching degree between the search term and the first field; and
determine a similarity between the first field and the search term based on the first prefix matching degree and the first suffix matching degree.

11. The electronic device according to claim 10, wherein the instructions further cause the electronic device to:
determine a keyword of the search term and a keyword of the first field; and
determine a keyword matching degree between the search term and the first field based on the keyword of the search term and the keyword of the first field, wherein the instructions for determining the similarity between the first field and the search term based on the first prefix matching degree and the first suffix matching degree, further cause the electronic device to:
determine the similarity between the first field and the search term based on the first prefix matching degree, the first suffix matching degree, and the keyword matching degree.

12. The electronic device according to claim 10, wherein the first field is a field comprised in the target data table.

13. The electronic device according to claim 12, wherein the instructions further cause the electronic device to:
output the first field in response to the similarity between the first field and the search term being greater than or equal to a preset threshold.

14. The electronic device according to claim 12, wherein the instructions further cause the electronic device to:
obtain an alias of the first field as a second field in response to the similarity between the first field and the search term being less than a preset threshold;
determine a second prefix matching degree between the search term and the second field and a second suffix matching degree between the search term and the second field;
determine a similarity between the second field and the search term based on the second prefix matching degree and the second suffix matching degree; and
output the first field in response to the similarity between the second field and the search term being greater than or equal to the preset threshold.

15. The electronic device according to claim 10, wherein the first field is an alias of a third field, and the third field is a field comprised in the target data table.

16. The electronic device according to claim 15, wherein the instructions further cause the electronic device to:
output the first field as a recommended search term in response to the similarity between the first field and the search term being greater than or equal to a preset threshold.

17. The electronic device according to claim 15, wherein the instructions further cause the electronic device to:
output the third field in response to the similarity between the first field and the search term being greater than or equal to a preset threshold.

18. The electronic device according to claim 15, wherein the instructions further cause the electronic device to:
input a prompt into a large model, wherein the prompt comprises at least a target field and an association relationship between the target field and another field in the target data table, the target field is a field in the target data table, the target field comprises the first field or the third field, and the prompt is used to prompt the large model to generate an alias for the target field based on the association relationship and/or the target field; and
obtain the alias of the target field that is output by the large model.

19. A non-transitory computer-readable storage medium, comprising instructions, wherein the instructions instruct a device to:
obtain a search term input by a user, the search term being used to search for a field in a target data table;
obtain a first field to be matched, the first field being a field related to the target data table;
determine a first prefix matching degree between the search term and the first field and a first suffix matching degree between the search term and the first field; and
determine a similarity between the first field and the search term based on the first prefix matching degree and the first suffix matching degree.

20. The non-transitory computer-readable according to claim 19, wherein the first field is a field comprised in the target data table.
